(19) United States
(12) Patent Application Publication
(10) Pub. No.: US 2014/0040226 A1
(43) Pub. Date: Feb. 6, 2014

(54) PROVIDING APPLICATION RESULT AND PREVIEW

(71) Applicants: Shajib Sadhukha, Seattle, WA (US); Amit Kumar, Redmond, WA (US); Michael Van Snellenberg, Seattle, WA (US); Li Jiang, Bellevue, WA (US)

(72) Inventors: Shajib Sadhukha, Seattle, WA (US); Amit Kumar, Redmond, WA (US); Michael Van Snellenberg, Seattle, WA (US); Li Jiang, Bellevue, WA (US)

(73) Assignee: MICROSOFT CORPORATION, Redmond, WA (US)

(21) Appl. No.: 13/563,605

(22) Filed: Jul. 31, 2012

(51) Int. Cl. G06F 17/30

(52) U.S. Cl. 707/706; 707/E17.108

(57) ABSTRACT

Applications (“apps”), through which a service may be accessed, may be identified to a user, along with a preview of the app. In one example, a user performs a search for a service. The search engine may return the web site through which the service is provided, and/or the app associated with that service. Preview content that describes the app may also be provided. The content may be variable, and may be filled in based on contextual information such as a search query string or user information. If the app is installed, then clicking, tapping, or otherwise activating the app may launch the app, possibly with context information being provided to the app. If the app is not installed, then a link to obtain the app may be provided.

### BACKGROUND

The way in which users interact with online services is rapidly shifting from a browser-based approach to an application (or “app”) based approach. As users spend more time on smart phones and tablets, users often seek the enhanced experience that an app can provide with an online service, as compared with accessing that service through a browser.

One issue that arises with regard to the use of apps is the fact that search engines are generally designed to return Uniform Resource Locators (“URLs”) of a service's web site, rather than the app associated with that service. Thus, search results may contain links to the web site associated with a service, and may also contain a preview of the web site. This type of search result worked well in the past, when an online service was effectively synonymous with its URL. However, now that apps are a common way for users to access a service, a user may be more interested in the app results than in the URL results.

### SUMMARY

When a service is shown to a user (e.g., in a set of search results), the user may be shown information relating to the app for that service. For example, the user may be shown the name of the official app for the service, a preview of the app, or—if the app is not installed on the user's device—an install button for the app. In this way, a user can be shown information about a service, where the information is relevant to the way in which the user is likely to interact with that service—e.g., through the service's app.

When a user performs a search, the search engine may discover various web sites that are responsive to the search. The search engine may then determine whether there is an app associated with a given web site result. If there is an app associated with the site, the search engine results page may list the app along with its corresponding web site result. When determining whether an app is associated with the site, the search engine may look specifically for the official app associated with the site (although the service could also look for unofficial or third-party apps).

When the results are to be displayed to a user, the results may include a web site (or URL) result together with its corresponding app. If the app is installed on the user's device, then a preview of the app's content may be shown. If the app is not installed, then a link (or other element) that allows the user to install the app may be shown. If a preview is shown, the content of the preview may be based on various pieces of information, such as the user's original query that generated the search result, or an action code that is derived from the user's query.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram of an example scenario in which a user requests information and receives app results.

FIG. 2 is a flow diagram of an example process in which app and/or previews may be provided and/or displayed with search results.

FIG. 3 is a flow diagram of an example process of displaying an app result and launching an app.

FIG. 4 is a block diagram of a device that shows certain example search results.

FIG. 5 is a block diagram of example action codes.

FIG. 6 is a block diagram of an example of using various app results.

FIG. 7 is a block diagram of example components that may be used in connection with implementations of the subject matter described herein.

### DETAILED DESCRIPTION

Many users interact with online services through applications, or “apps.” In the past, online services were typically accessed through a general-purpose browser. Recently, however, many online service providers have provided apps for use with their services. The apps often provide an enhanced user experience as compared with accessing the same service through a browser. Many users use online services on relatively small devices such as smart phones or tablets, and an app can provide an experience that is optimized for a particular device.

One issue that arises in the use of apps to access services is that new services are generally discovered through search engines, and search engines normally identify services by the Uniform Resource Locators (“URLs”) of their web sites. This paradigm made sense in the early days of web-based online services, since a service was typically synonymous with the URL of its web site. However, when users use apps to access web sites, the users may be more interested in app results than in the web site results.

The subject matter described herein provides a technique for providing app results together with search results. The app results may be provided with various types of preview information, or may be provided with installation information if the app is not installed. When a user seeks information online (e.g., by entering a query into a search engine), the user may be provided with a result that identifies a service that relates to what the user is looking for. The result may indicate the URL of the service's web site, and may also indicate an app that allows the user to access the service. If the app is not installed on the user's device, then the indication of the app may contain a link (or other element) that allows the user to install the app. If the app is installed, then the indication of the app that appears in the search results may contain a preview of the app's content.

The preview may contain various type of information. For example, the preview may be a simple fixed text string that exists in the app's metadata. Or, the app's metadata may contain a string with variable fields, and the fields may be filed in from contextual information about the user's search. The context that is used to fill in the fields may be the user's original query. When an app exists on the user's device, it may be launched from the inline app result on the results page (e.g., by clicking or tapping on the inline app result). Upon launch of the app, the app may be provided with various pieces of information that allow the app to start in a state that is relevant to the user's search. For example, the app may be provided with the user's original search query, or an action code that is derived from the user's original search query. The app may use this information to start in a particular mode, or to show the user particular kinds of information that relate to the user's query.

For example, a user might enter the search query “rent the grey dvd” (referring to the 2011 movie entitled “The Grey”). A search engine might return Redbox as a service that is relevant to that query. The Redbox service may be identified in the results by the URL of the Redbox service's web site. However, in addition to this URL, the results may also include the Redbox app. If the Redbox app is not installed on the user's device, then the Redbox result may include a link (or other element) that allows the user to install the Redbox app. (The link to install the app might only be shown if a version of the app for the user's device exists.) If the Redbox app is installed, then the Redbox result may include a preview of the Redbox app. The preview might be a simple, fixed text string, such as “Rent the latest DVDs from local kiosks.” Or, the preview might be a text string with a variable field, such as “Rent <movie name> from local kiosks,” where “<movie name>” would be filled in from the context of the user's query. In this example, it could be gleaned from the user's query that the user is searching for “The Grey,” so the preview string that is actually shown to the user might read, “Rent The Grey from local kiosks.” If the user chooses to use the app, the app may be launched with the relevant context that allows the app to show the user the information that the user is looking for. For example, the app may be provided with the text of the user's original query at the time of launch, which allows the app to launch on the rental screen for “The Grey” (rather than launching on Redbox's home screen). Additionally (or as an alternative) an action code may be inferred from the user's query, and this action code may be provided to the application. For example, a system may maintain several action codes, and “rent movie” may be one of the action codes. Based on an analysis of the user's query, it may be determined that “rent movie” is the appropriate action code associated with that movie, so the “rent movie” action code may be passed to the Redbox app upon launch, and the app may interpret this action code in order to launch to the appropriate screen.

It is noted that (a) a system that provides a URL result for an online service together with an app result (where the app, if launched, would allow the user to access the online service) is different from, and not obvious in view of, (b) a system that provides the URL of the app itself. In the former case, the system is returning the URL of the service, and is also identifying an alternative mechanism (the app) through which the service can be accessed. The app result that is provided with the URL may or may not contain the location of the app, and may or may not be in the same domain as the URL result. By contrast, in the latter case, the search result that is being provided is the URL of the app. For example, in the former case, in response to a query for “service” a search engine might return the main result service.example.com (the URL result), together with an indication of an app named “Service App” (an abstract app result that might not even be associated with any particular URL). In the latter case, the service query might return, as the main result, the URL “http://download-repository-company.example.com/download/app.exe”. In the latter case, the result is a URL, but it is not the URL of a service; rather it is the URL of a particular executable file that, if downloaded, could be used to access a particular service. The URL from which this executable file could be downloaded may even be in a different domain from the service itself, as shown in the download-repository.example.com URL above. Thus, the scenario of system (a) is different from, and not obvious in view of, the scenario of system (b).

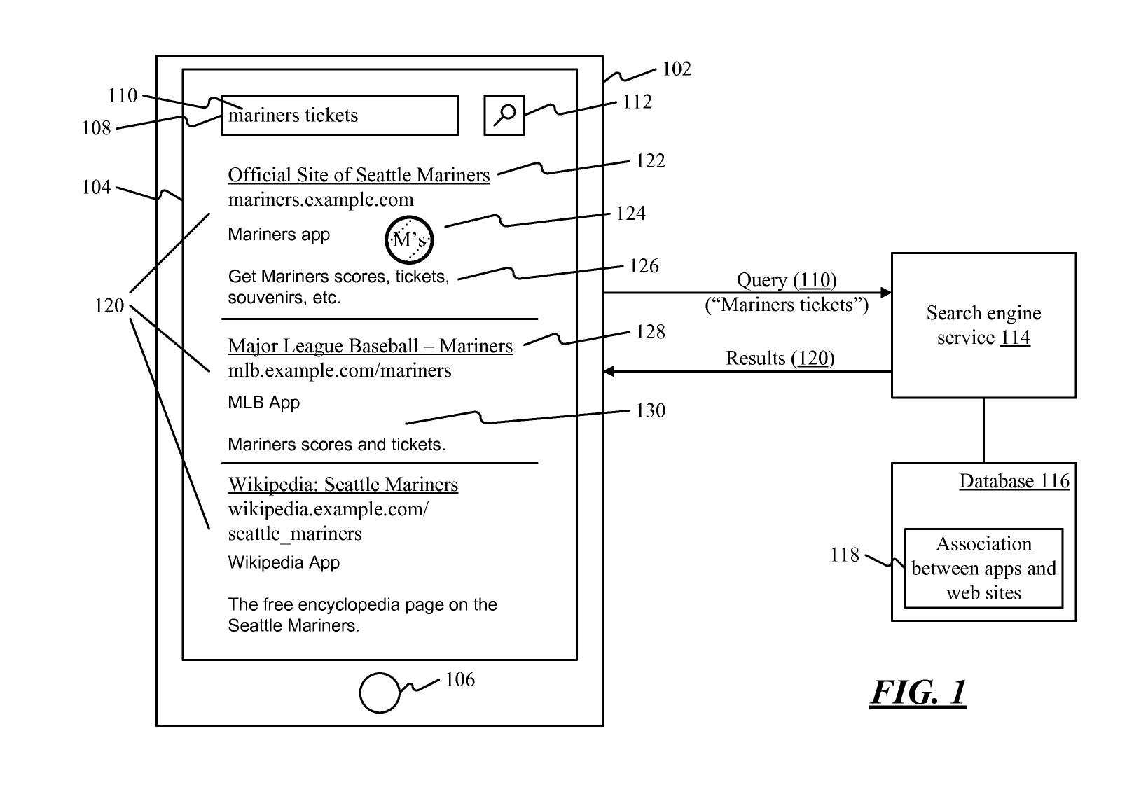

Turning now to the drawings, FIG. 1 shows an example scenario in which a user requests information and receives app results with previews. Device 102 is a device such as a wireless telephone, tablet computer, personal computer, handheld music player, handheld computer, or any other type of device that has some computing capability. In the example shown in FIG. 1, device 102 has an appearance that is commonly associated with that of a smart phone, although the subject matter herein can be used with any appropriate type of device, and is not limited to a smart phone. Device 102 may have input and output mechanisms—e.g., device 102 may have touch screen 104 (which both displays output and receives input), and may also have an escape button 106, which may be used to request various actions (such as returning the user interface on device 102 to its desktop or home screen). The input and output mechanisms shown are merely examples; device 102 could have any type of input and/or output mechanisms. Device 102 may also have components such as a memory, a disk drive, a processor, one or more network interfaces (e.g., for cellular and WiFi communication), one or more Universal Serial Bus (USB) ports, a microphone, a speaker, jacks for connecting external audio input and output devices, or may have any other type of components.

One action that a user may perform on device 102 is to request a search. The search may be requested through a browser on the device, or there may be a purpose-built search app that facilitates a search. Either the browser interface for the search engine, or the search app, may have a search box 108 into which a user may enter a query 110. In the example shown, the query 110 that is entered is “mariners tickets.” The browser interface or search app may have a search button 112 that the user activates to submit a search, or the search engine may operate an incremental search feature, in which the search engine returns results that are refined continually as the user types.

After query 110 is composed (or while query 110 is being composed, in the case of incremental search), query 110 is sent to search engine service 114. Search engine service 114 may operate one or more servers that maintain indices of content, and may also operate software that identifies particular items of content based on relevance to the query. By comparing query 110 with the indices, search engine service 114 may identify particular web sites that are relevant to query 110. Search engine service 114 may have, or may otherwise make use of, a database 116, which contains associations 118 between apps and web sites. Search engine service 114 may use the information in database 116 to provide app results along with the web site (URL) results. Regardless of the manner in which apps are discovered, the apps may be included in the results 120 that are returned to device 102 by search engine service 114.

When results 120 are returned to device 102, they may be displayed by the search app or browser search interface, for viewing by the user of device 102. In the example of FIG. 1, three results are shown: the Mariners' official site (mariners.exmaple.com), the Major League Baseball (MLB) site for the Mariners team (mlb.example.com/mariners), and the Wikipedia page for the mariners (wikipedia.example.com/seattle_mariners). Each of results 120, in this example, is a web service that is identified by its URL. For two of the results, the actual result is a specific sub-section of the top-level site (/mariners in the case of the Major League Baseball site, /seattle_mariners within the Wikipedia site). Like many queries, the phrase “mariners tickets” could have other meanings—e.g., tickets for an activity involving cargo ships or ocean navigation—but for the purpose of this example it will be assumed that search engine service 114 is correct in its understanding that the user of device 102 is seeking baseball tickets.

In the example shown, search engine service 114 has discovered an app associated with each of the results. The Mariners have an app, Major League Baseball has an app, and Wikipedia has an app. Thus, identifications of the app results are shown together with identifications of the corresponding site results. Turning to the Mariners site result (result 122), it can be seen that the Mariners app (app 124) is shown with the result, along with a logo (shown in this example as the text “M's” inside a ball). Additionally, the listing of app 124 shows preview information 126, which indicates what type of information a user can expect when using app 124. In this example, the preview information 126 is the text, “Get Mariners scores, tickets, souvenirs, etc.”

The Major League Baseball URL result (result 128) is the Mariners' page on the mlb.example.com web site. Mlb.example.com is a web site that covers all Major League Baseball teams, not just the Mariners. Only the section of that web site (indicated by “/mariners” in the URL) relates specifically to the Mariners. There is an app result (app 130) associated with the mlb.example.com web site. App 130 may be the app for the entire mlb.example.com web site, but the preview associated with that app result may be specifically tailored for the Mariners, since the user was asking specifically for Mariners tickets, rather than tickets for all Major League Baseball. Thus, the preview associated with the MLB app says, “Mariners scores and tickets.” (The fact that the preview refers to the Mariners may be based on the fact that the query that generated the mlb.example.com result included a reference to the Mariners. Techniques that are discussed below may be used to tailor the preview are discussed below in connection with subsequent figures.) If the MLB app were launched from results 120, it might launch on a screen that specifically relates to the Mariners; techniques are discussed below that can be used to communicate, to an app, the information that the app would use to decide which screen to launch on.

Finally, results 120 include a Wikipedia page on the Seattle Mariners. As can be seen, the result includes a specific section of the wikipedia.example.com web site (indicated by “/seattle_mariners” in the URL). Additionally, the app result is the Wikipedia app, with the preview tailored to the Mariners-related query (with the preview being “The free encyclopedia page on the Seattle Mariners”).

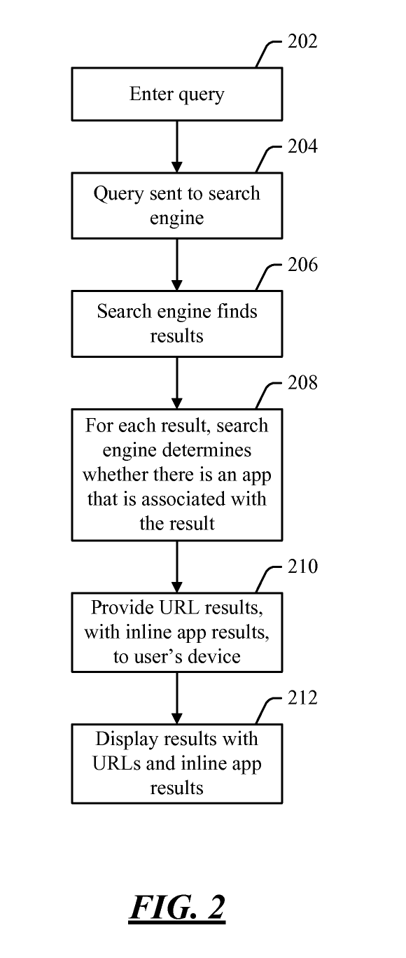

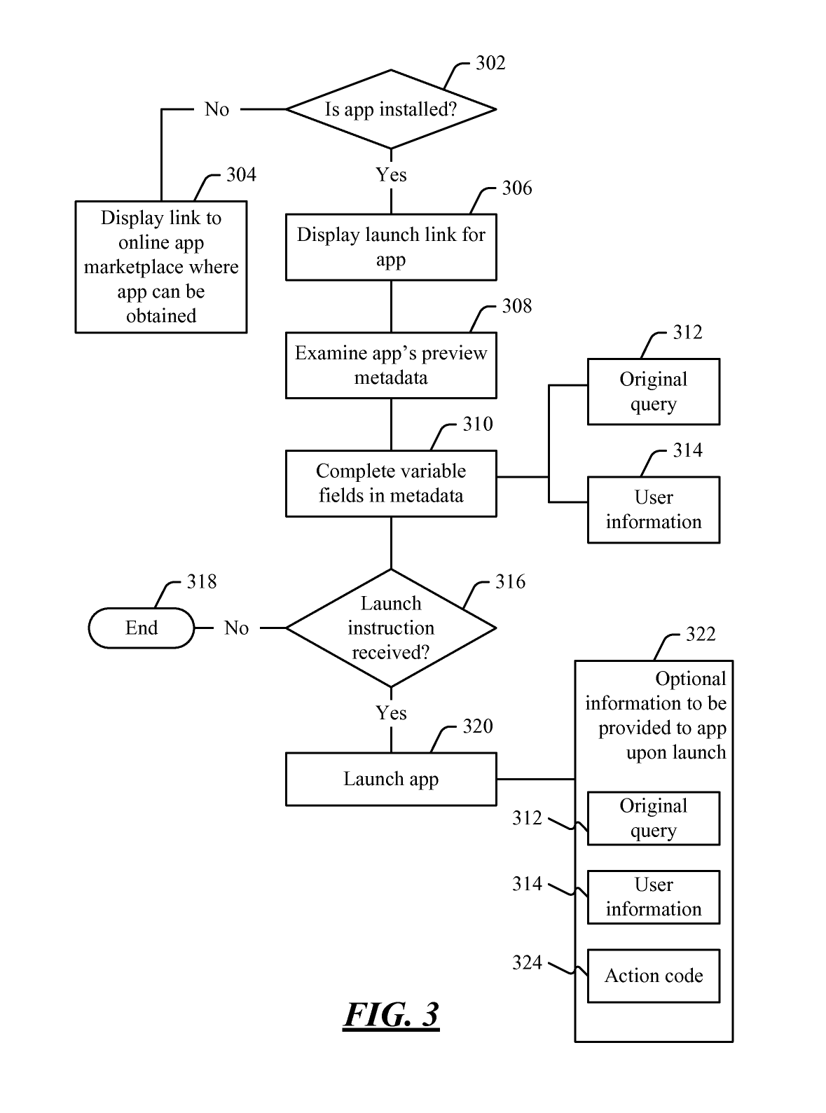

FIG. 2 shows an example process in which app and/or previews may be provided and/or displayed with search results. Before turning to a description of FIG. 2, it is noted that the flow diagrams contained herein (both in FIG. 2 and in FIG. 3) are described, by way of example, with reference to components shown in FIG. 1, although these processes may be carried out in any system and are not limited to the scenario shown in FIG. 1. Additionally, each of the flow diagrams in FIGS. 2 and 3 shows an example in which stages of a process are carried out in a particular order, as indicated by the lines connecting the blocks, but the various stages shown in these diagrams can be performed in any order, or in any combination or sub-combination.

At 202, a user enters a query. Query 110 (shown in FIG. 1) is an example of such a query. At 204, the query is sent to a search engine. At 206, the search engine finds results that is responsive to the query. In one example, the results are URLs of web sites that relate to the query.

At 208, for each result found, the search engine determines whether there is an app that is associated with the result. In one example, the search engine may assess how reliably the app is associated with the web site, and may impose some level of reliability as a criterion before concluding that a particular app is associated with a particular result. For example, there may be many different apps associated with a web site such as Major League Baseball, only one of which (or one per platform) is the “official” app for that web site. Other apps that might appear to relate to the Major League Baseball site might be apps prepared by unauthorized third parties. Many unauthorized third-party apps are benign, or even salutary, but some are unreliable or harmful. Therefore, in one example, the search engine might consider an app to be associated with a URL only if the app is an “official” app for the web site located at that URL. In one example, there may be a system in place for webmasters and app developers to declare, to a search engine operator, their official relationship to each other, thereby simplifying the process of determining which apps and web sites are officially associated with each other. However, the subject matter herein is not limited to any particular method of determining which apps are associated with a web site. A search engine may, in accordance with the subject matter described herein, find that an app is associated with a web site even if no official relationship between the app and the web site exists.

At 210, the search engine's URL results may be provided with the app results inline. FIG. 1, described above, shows an example where the app results are provided inline with the search results, since an app is shown in visual association with the URL result. (One example way to show an app result inline with a URL result is to show the app below the search result. However, other forms of visual association between the URL result and app results can also constitute showing the app results inline.)

At 212, the URL results, together with the inline app results, may be displayed. For example, if the search engine results the results to the device on which the user entered the query, the browser or search app may display a screen with the URL results and app results together. Displaying the app result may involve determining whether the app is installed on the user's device, and—when applicable—filling in variable fields in the app's preview.

FIG. 3 shows an example process of displaying an app result and launching an app. In one example, the process of FIG. 3 may take place on the user's device after the search engine has provided the results to the device. However, portions of the process shown in FIG. 3 may take place at locations other than the user's device.

At 302, it is determined whether the app is installed. If the app is not installed, then a link (or other activatable element) to install the app may be displayed (at 304). In one example, the link or other element points to an online app marketplace where the app can be obtained. (Before displaying a link to install the app, a determination might be made as to whether a version of the app for the user's device exists. If no such version exists, then the link to install the app might be omitted.) When the user clicks, taps, or otherwise activates the link, the installation of the app may begin, or the user may be directed to the location at which the app can be obtained.

If the app is installed, then the launch link for the app may be displayed (at 306). Examples of app results are shown in FIG. 1. Any of the app results may be made activatable, such that clicking, tapping, or otherwise activating the app result causes the app to be launched.

In addition to displaying the name of the app, the app result may include a preview of the app. The actual content of the preview may be generated by the search engine, or may be generated on the user's device. Each app may be associated with certain metadata that describes the preview to be shown. Thus, in order to generate the preview content, the app's preview metadata is examined (at 308).

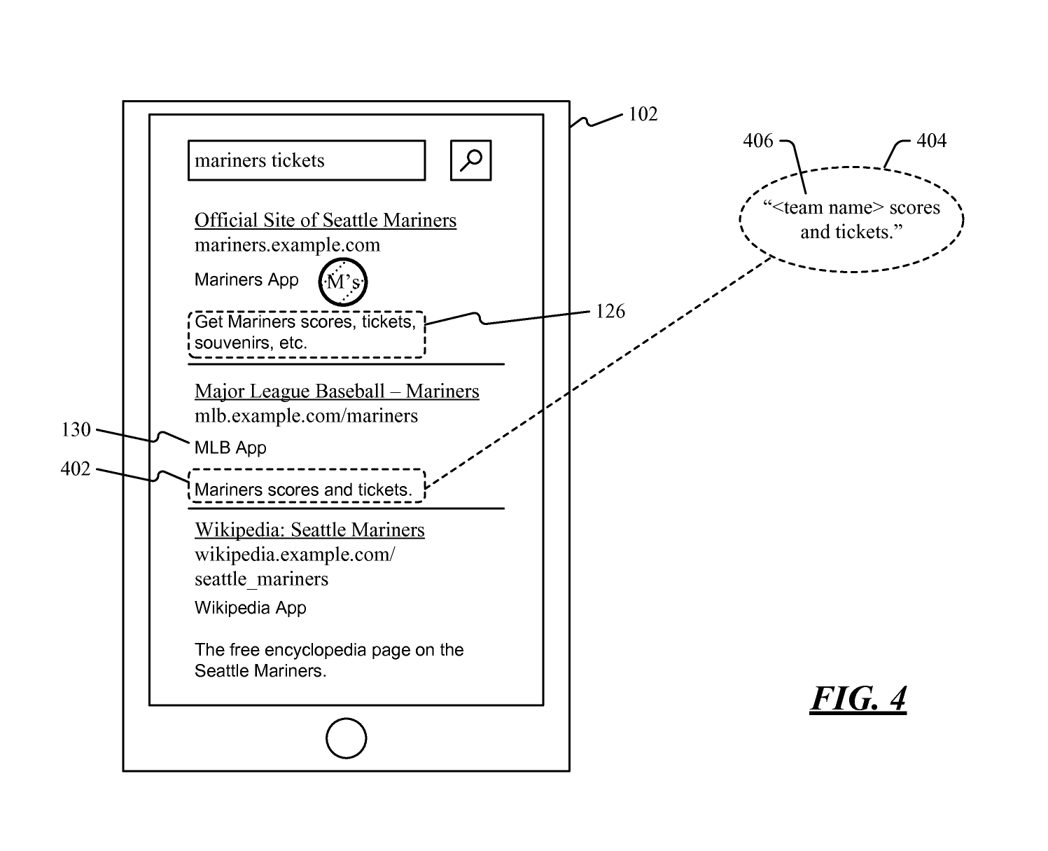

An examination of the app's preview data may reveal a constant string without any variable fields. For example, with reference to FIG. 4 (which shows the same device 102 that was introduced in FIG. 1), the preview information 126 for the Mariners app 124 may simply contain the constant string “Get Mariners scores, tickets, souvenirs, etc.” Such a string is “constant” in the sense that it does not contain any variable fields to be filled in, or any other information that is left to be determined. On the other hand (and again with reference to FIG. 4), the preview information 402 for the Major League Baseball app result (app 130) may have be created from metadata having variable fields. For example, since the Major League Baseball app may be designed to work with any Major League Baseball team, the metadata 404 that describes the preview for that app may contain a variable field 406 (“<team name>”) into which the name of a particular team may be filled. In the example shown in FIG. 4, the team name that is filled into field 406 is “Mariners”, since the user's query 110 relates to the Mariners. However, if a different query had been entered, then field 406 could have been filled in with different information.

Thus, returning now to FIG. 3, at 310 any variable fields that exist in the app's preview metadata may be filled in with appropriate information. Various types of information may be used as a basis to fill in the fields, of which some examples are shown in FIG. 3. One example piece of information that may be used to fill in the fields is the original query 312 that generated the search results. Another example piece of information is user information 314, which may include information about the user's identity, the user's location, the user's expressed preferences, or any other information that the user has chosen to share about himself or herself. (To protect the user's interest in privacy, information about the user may be used pursuant to appropriate permission obtained from the user, and appropriate disclosure made to the user.) For example, if the user has chosen to share his current location, and that current location is the greater Seattle area, this fact might have prompted the word “Mariners” to be filled into the team name field, even if the user had entered a query such as “baseball tickets” that did not explicitly name the Mariners. Software that determines how fields are to be filled in, based on information such as query 312 or user information 314, may exist on the user's device and/or at the search engine server. It is noted that filling in fields is merely one way that variable preview information could be completed. More generally, an app's preview metadata could include any arbitrary algorithm that generates a preview from any type of information; metadata that has fixed text with variable fields to be filled in (as shown in metadata 404 of FIG. 4) is merely one example of such an algorithm.

Returning again to FIG. 3, once an app is displayed to the user, a launch instruction may be received. An example of such a launch instruction is the user's clicking or tapping on (or otherwise activating) an app that appears in a set of search results. If no such launch instruction is received (as determined at 316), then the process of FIG. 3 ends (at 318) without launching an app.

On the other hand, if a launch instruction is received, then the app is launched at 320. An app may have the ability to take receive various types of information at the time of launch. The app may react to the information received in various ways. For example, the app may choose the information to display to the user based on the information received. Or, an app that has plural screens may choose a particular screen to display based on the information received (e.g., the MLB app may choose the Mariners screen as opposed to the screen of another baseball team). FIG. 3 shows various types of information 322 that may be provided to the app upon launch.

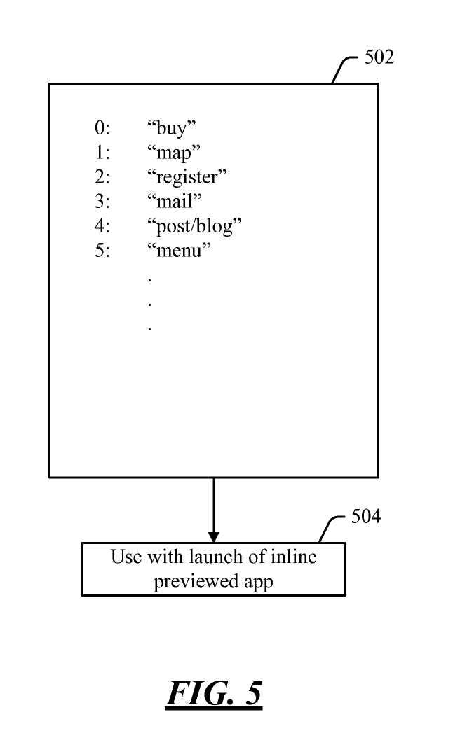

One type of information that may be provided to the app is the original query 312. For example, if the original query is the text “mariners tickets,” then this text may be provided to the app. In another example, user information 314 (the nature of which is discussed above) may be provided to the app. In another example, an action code 324 may be provided to the app. Action code 324 may be a simplified representation of the action that the user is attempting to perform, as deduced from the query and other context. In effect, the action code may be an attempt to draw a sharp conclusion from the imprecise information contained in a query. For example, the query “mariners tickets” does not explicitly say that the user wants to buy tickets, but it may be a reasonable conclusion that the action that the user is looking to do is “buy”. Similarly, if the user enters the query “where is Safeco field”, the query does not explicitly say that the user wants a map of the area around Safeco field, but it may be a reasonable inference from the nature of the query that the user is looking for a map. Thus, a system may maintain action codes for several common (or even not-so-common) actions, and may assign an action code based on a query, or based on the user information discussed above. FIG. 5 shows some example action codes 502. These action codes may be used with the launch of an app that has been returned as an inline search result and that has been displayed with a preview (block 504). In the example shown, the action codes include “buy”, “map”, “register”, “mail”, “post/blog”, “menu” (referring to “get a food menu”). However, the action codes shown are merely examples. Any other appropriate action codes could be used.

Returning now to FIG. 3, once the information 322 has been provided to the app upon launch, the app may decide what to do with that information. For example, if the Major League Baseball app is launched, that app may use the query “mariners tickets” as a basis to launch on the Mariners screen (as opposed to the screen for some other team). Or, if the action code “buy” has been assigned to the user's query and has been provided to the app, then the app may use that action code “buy” (possibly in combination with the word “tickets” from the query) as a basis to launch on the ticket-purchase screen. The app may make any appropriate use of the information that it receives upon launch. However, regardless of the use that the app makes of the information that it receives, the ability to send the app information about the context in which the app was found by the user (such as the search query, action code, or user information) may tend to make the experience of finding and using an app more seamless than it would be if this information were not provided to the app.

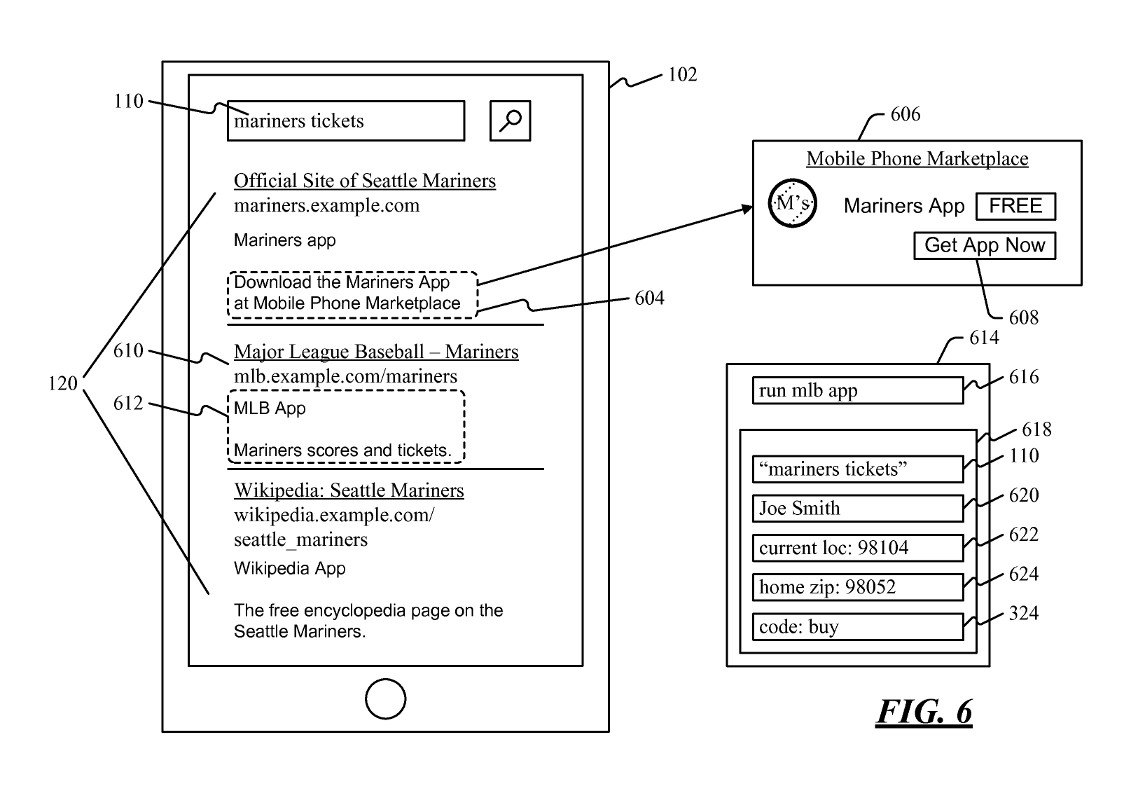

FIG. 6 shows how various app results may be used. Device 102 is the device that was introduced in FIG. 1. On this device, the user has entered query 110, and has received results 120. One of the results is the Official Site of the Seattle Mariners, which has the URL mariners.example.com. The search engine, in this example, has determined that there is an app associated with the Mariners site. It has also been determined that device 102 does not have the Mariners app installed. (This determination may be made, for example, by device 102 or by the search engine.) Thus, the app result 604 that is presented with the Mariners site is a link to download and/or install the app. If the user activates the link, the user may be taken to an app marketplace 606, at which the app may be obtained. (In this example, the Mariners app is free, although in another example the marketplace might charge for a particular app.) If the user clicks the “get app now” button 608, the app may be installed on device 102.

Another result 610 on device 102 is the Mariners section of the Major League Baseball site. The URL for this site is mlb.example.com/mariners, and there is an app result 612 associated with this site. The app result is the Major League Baseball app. In this example, the Major League Baseball site is installed on device 102, so the app result, if activated, will launch the existing app. Box 614 shows examples of what happens when the user activates app result 612.

When app result 612 is activated, the app is launched, as represented by the “run” command 616. (The command that launches the app could take any form appropriate for device 102; a text command to “run” the app is merely one example of such a form.) Additionally, various piece of information 618 may be provided to the app at the time of launch (as discussed above in connection with FIG. 3). In the example shown in FIG. 6, this information may include the original query 110; the user's name 620; the user's current location 622 (which may be represented as a zip code, or by some other information such as latitude and longitude); the user's home location 624 (which, again may be represented by a zip code or by some other piece of information), and an action code 324 (the nature of which is described above). As noted above, in order to protect the user's interest in privacy, information pertaining to the user may be provided to the app pursuant to appropriate permission obtained from the user.

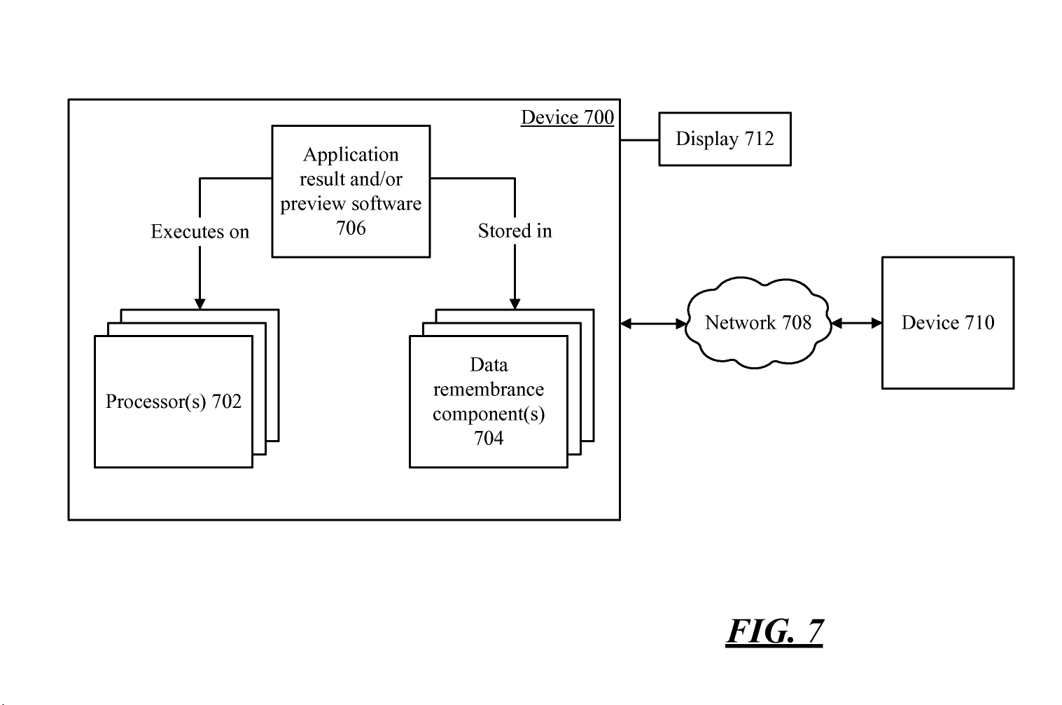

FIG. 7 shows an example environment in which aspects of the subject matter described herein may be deployed.

Device 700 includes one or more processors 702 and one or more data remembrance components 704. Device 700 may be any type of device with some computing power. A smart phone is one example of device 700, although device 700 could be a desktop computer, laptop computer, tablet computer, set top box, or any other appropriate type of device. Processor(s) 702 are typically microprocessors, such as those found in a personal desktop or laptop computer, a server, a handheld computer, or another kind of computing device. Data remembrance component(s) 704 are components that are capable of storing data for either the short or long term. Examples of data remembrance component(s) 704 include hard disks, removable disks (including optical and magnetic disks), volatile and non-volatile random-access memory (RAM), read-only memory (ROM), flash memory, magnetic tape, etc. Data remembrance component(s) are examples of computer-readable (or device-readable) storage media. Device 700 may comprise, or be associated with, display 712, which may be a cathode ray tube (CRT) monitor, a liquid crystal display (LCD) monitor, or any other type of monitor. Display 712 may be an output-only type of display; however, in another non-limiting example, display 712 may be (or comprise) a touch screen that is capable of both displaying and receiving information.

Software may be stored in the data remembrance component(s) 704, and may execute on the one or more processor(s) 702. An example of such software is application result and/or preview software 706, which may implement some or all of the functionality described above in connection with FIGS. 1-6, although any type of software could be used. Software 706 may be implemented, for example, through one or more components, which may be components in a distributed system, separate files, separate functions, separate objects, separate lines of code, etc. A device (e.g., smart phone, personal computer, server computer, handheld computer, tablet computer, set top box, etc.) in which a program is stored on hard disk, loaded into RAM, and executed on the device's processor(s) typifies the scenario depicted in FIG. 7, although the subject matter described herein is not limited to this example.

The subject matter described herein can be implemented as software that is stored in one or more of the data remembrance component(s) 704 and that executes on one or more of the processor(s) 702. As another example, the subject matter can be implemented as instructions that are stored on one or more device-readable media. Such instructions, when executed by a phone, a computer, or another machine, may cause the phone, computer, or other machine to perform one or more acts of a method. The instructions to perform the acts could be stored on one medium, or could be spread out across plural media, so that the instructions might appear collectively on the one or more computer-readable (or device-readable) media, regardless of whether all of the instructions happen to be on the same medium. The terms “computer-readable media” and “device-readable media” do not include signals per se; nor do they include information that exists solely as a propagating signal. It will be understood that, if the claims herein refer to media that carry information solely in the form of a propagating signal, and not in any type of durable storage, such claims will use the terms “transitory” or “ephemeral” (e.g., “transitory computer-readable media”, “ephemeral computer-readable media”, “transitory device-readable media”, or “ephemeral device-readable media”). Unless a claim explicitly describes the media as “transitory” or “ephemeral,” such claim shall not be understood to describe information that exists solely as a propagating signal or solely as a signal per se. Additionally, it is noted that “hardware media” or “tangible media” include devices such as RAMs, ROMs, flash memories, and disks that exist in physical, tangible form; such “hardware media” or “tangible media” are not signals per se. Moreover, “storage media” are media that store information. The term “storage” is used to denote the durable retention of data. For the purpose of the subject matter herein, information that exists only in the form of propagating signals is not considered to be “durably” retained. Therefore, “storage media” include disks, RAMs, ROMs, etc., but does not include information that exists only in the form of a propagating signal because such information is not “stored.”

Additionally, any acts described herein (whether or not shown in a diagram) may be performed by a processor (e.g., one or more of processors 702) as part of a method. Thus, if the acts A, B, and C are described herein, then a method may be performed that comprises the acts of A, B, and C. Moreover, if the acts of A, B, and C are described herein, then a method may be performed that comprises using a processor to perform the acts of A, B, and C.

In one example environment, device 700 may be communicatively connected to one or more other devices through network 708. Device 710, which may be similar in structure to any of the examples of device 700, is kind of device that can be connected to device 700, although other types of devices may also be so connected.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A device-readable medium that stores executable instructions to identify services to a user, the executable instructions, when executed by a device, causing the device to perform acts comprising:
receiving a query from said user;
sending said query to a search engine;
receiving, from said search engine, a set of results, a first result within said set of results comprising a first identification of a Uniform Resource Locator (URL) of a service and a second identification of an application that provides access to said service; and
displaying said first result by showing, on said device, said first identification of said service together with said second identification of said application, said second identification of said application comprising a link to install said application or a preview of said application.

2. The device-readable medium of claim 1, said acts further comprising:
determining that said application is not installed on said device, said second identification of said application comprising said link to install said application, said link pointing to an online application marketplace.

3. The device-readable medium of claim 1, said acts further comprising:
determining that said application is installed on said device, said application having metadata that comprises a fixed preview string, said second identification of said application comprising said fixed preview string.

4. The device-readable medium of claim 1, said acts further comprising:
determining that said application is installed on said device, said application having metadata that has to be completed in order to be displayed as said preview; and
completing said metadata to create said preview, said second identification of said application comprising said preview.

5. The device-readable medium of claim 4, said metadata comprising a field to be filled in, said completing comprising filling in said field in said metadata using context information on said device, said preview comprising said metadata with said field filled in.

6. The device-readable medium of claim 5, said context information comprising said query.

7. The device-readable medium of claim 1, said acts further comprising:
determining that said application is installed on said device, said second identification of said application comprising said preview;
receiving an indication that said second identification of said application has been activated by said user;
launching said application and, at a time of said launching, providing to said application, context information.

8. The device-readable medium of claim 7, said context information comprising said query.

9. The device-readable medium of claim 7, said context information comprising a location or expressed preference of said user.

10. The device-readable medium of claim 7, said context information comprising an action code that is determined from said query.

11. A method of identifying services to a user, the method comprising:
using a processor to perform acts comprising:
receiving, from a device of a user, a query;
identifying a service that is responsive to said query;
determining that there is an application through which said service can be accessed;
creating a preview of said application based on metadata associated with said application; and
providing, to said device, a set of results to be displayed on said device, said set of results comprising a Uniform Resource Locator (URL) of a web site of said service and an identification of said application that is inline with said URL, said identification of said application comprising said preview.

12. The method of claim 11, said acts further comprising:
determining that said application is installed on said device, said application having metadata that comprises a fixed preview string, said identification of said application comprising said fixed preview string.

13. The method of claim 11, said acts further comprising:
determining that said application is installed on said device, said application having metadata that has a field that is not filled in; and
filling in said field using said query, said preview comprising said metadata with said field filled in.

14. A device comprising:
a memory;
a processor;
a display; and
an application preview component that is stored in said memory, that executes on said processor, that receives a query from a user, that sends said query to a search engine, that receives, from said search engine, a set of results, a first result within said results comprising a first identification of a link to a service and a second identification of an application that provides access to said service, said application preview component displaying said first result by showing, on said display, said first identification of said service and said second identification of said application, said second identification of said application comprising a preview of said application.

15. The device of claim 14, said application preview component determining that said application is installed on said device, said application having metadata that comprises a fixed preview string, said second identification of said application comprising said fixed preview string.

16. The device of claim 14, said application preview component determining that said application is installed on said device, said application having metadata that comprises a field that has to be filled in order be displayed as said preview, said application preview component using said query to fill in said field and displaying said metadata, with said field being filled in, as said preview.

17. The device of claim 14, said application preview component determining that said application is installed on said device, said second identification of said application comprising said preview, said application preview component receiving an indication that said second identification of said application has been activated by said user, said application preview component launching said application, and said application preview component providing context information to said application at a time of launching said application.

18. The device of claim 17, said context information comprising said query.

19. The device of claim 17, said context information comprising a location or expressed preference of said user.

20. The device of claim 17, said context information comprising an action code that is determined from said query.
